(19) United States
(12) Patent Application Publication
(10) Pub. No.: US 2021/0109267 A1
(43) Pub. Date: Apr. 15, 2021

(54) OPTICAL FILTER AND DEVICE

(71) Applicant: VIAVI Solutions Inc., San Jose, CA (US)

(72) Inventors: William D. HOUCK, Santa Rosa, CA (US); Daniel MEYSING, Santa Rosa, CA (US)

(21) Appl. No.: 16/948,959

(22) Filed: Oct. 7, 2020

Related U.S. Application Data
(60) Provisional application No. 62/912,948, filed on Oct. 9, 2019.

(51) Int. Cl. G02B 5/28; G02B 5/22; G02B 1/11

(52) U.S. Cl. CPC G02B 5/282; G02B 1/11; G02B 5/22

(57) ABSTRACT

A device may include an image sensor to capture an image using light in a visible range; and an optical filter to filter light received by the image sensor, wherein the optical filter passes light in the visible range, and wherein the optical filter absorbs or reflects light in a wavelength range of 830 to 1600 nanometers (nm). An optical filter may include a layer that passes light in the visible range, and one or more filter elements, wherein the optical filter is absorptive or reflective of light in the wavelength range of 830 to 1600 nm. Numerous other aspects are provided.

### CROSS-REFERENCE TO RELATED APPLICATION

This Patent Application claims priority to U.S. Provisional Patent Application No. 62/912,948, filed on Oct. 9, 2019, and entitled “OPTICAL FILTER AND DEVICE.” The disclosure of the prior Application is considered part of and is incorporated by reference into this Patent Application.

### BACKGROUND

An optical filter is a device that selectively transmits, reflects, and/or absorbs light, incident on the optical filter, based on wavelength. An optical filter may be used to pass or transmit certain wavelengths of light to a device, such as an optical sensor, a camera, and/or the like.

### SUMMARY

According to some implementations, a device may include an image sensor to capture an image, using light in a visible range; and an optical filter to filter light before the light is received by the image sensor, wherein the optical filter passes light in the visible range, and wherein the optical filter absorbs or reflects light in a wavelength range of 830 to 1600 nanometers (nm).

According to some implementations, a camera may include an image sensor to capture an image, using light in a visible range; and a heat protection filter, wherein the heat protection filter passes light in the visible range, and wherein the heat protection filter absorbs or reflects light in a wavelength range of 830 to 1600 nm.

According to some implementations, an optical filter may include a layer that passes light in the visible range, and one or more filter elements, wherein the optical filter is absorptive or reflective of light in the wavelength range of 830 to 1600 nm.

### BRIEF DESCRIPTION OF THE DRAWINGS

FIG. 1 is a diagram of an example device described herein.

FIGS. 2 and 3 are diagrams of examples of optical filters of an example device described herein.

FIGS. 4-7 are diagrams illustrating example performance curves for optical filters, such as associated with an example device described herein.

### DETAILED DESCRIPTION

The following detailed description of example implementations refers to the accompanying drawings. The same reference numbers in different drawings may identify the same or similar elements.

An image sensor may be configured to generate a signal based on receiving light. For example, an image sensor of a camera may capture images in a visible range (e.g., approximately 400 nm to 660 nm) and/or the like. In some cases, light of a threshold intensity may be harmful for an image sensor, and certain wavelengths of light may not be filtered before reaching the sensor. For example, silicon of the image sensor may not absorb light outside of a certain range, and incident power of the undesired light may be absorbed into components of the image sensor (e.g., wire traces, dielectric structures, circuitry, and/or the like), thereby damaging or destroying the components. Thus, an image sensor may be damaged or degraded if the image sensor receives light of a threshold intensity in a given wavelength range, such as a wavelength range of 830 nm to 1600 nm.

An optical filter may pass one or more wavelength ranges of light and may absorb and/or reflect one or more other wavelength ranges of light. “Pass” is used interchangeably with “transmit” herein. A camera may include an optical filter that passes visible light based on which an image is to be captured. However, certain types of light may not be absorbed or reflected by an optical filter of some cameras. For example, the recent proliferation of light radar (LIDAR) lasers, which may operate at approximately 1550 nm wavelength, may cause damage to certain camera sensors since the LIDAR wavelength range is not filtered by many optical filters of cameras, causing LIDAR light to reach a sensor of the camera at a sufficient intensity to damage the sensor. Other sensing applications may use lasers in the range of 830-1000 nm (e.g., a near-infrared (NIR) range), which also may not be filtered by optical filters of cameras. Furthermore, the permissible intensity of LIDAR or similar lasers may be based on human eye safety standards (e.g., configured based on absorption characteristics of the vitreous humor and/or the cornea to avoid retina damage), which may be sufficiently powerful to damage visible range image sensors if the image sensor receives light of a threshold intensity in the wavelength range of 830-1600 nm. Still further, a self-driving vehicle may use a combination of LIDAR sensing and visible-range sensing or image capture to gather information regarding the self-driving vehicle's surrounding, so as the number of self-driving vehicles increases, degradation of the visible-range sensors of self-driving vehicles, user devices (e.g., smartphones, tablet computers, cameras, and/or the like), security cameras, and/or the like may increase.

Implementations described herein provide an optical filter that passes light in a certain range (e.g., a visible range) and that blocks light in a wavelength range of 830-1600 nm (e.g., associated with LIDAR or other laser applications). For example, the optical filter may have a threshold optical density in the wavelength range of 830-1600 nm. In some implementations, the optical filter may use a heat protection filter (e.g., a heat absorbance glass), a notch filter, a short wave pass filter, a polymeric filter, and/or the like. Some implementations described herein provide a sensor device that uses the optical filter described above. Thus, degradation or damage to optical sensors by LIDAR or laser applications may be reduced. This is particularly useful as the proliferation of LIDAR and other laser applications accelerates and adoption becomes widespread.

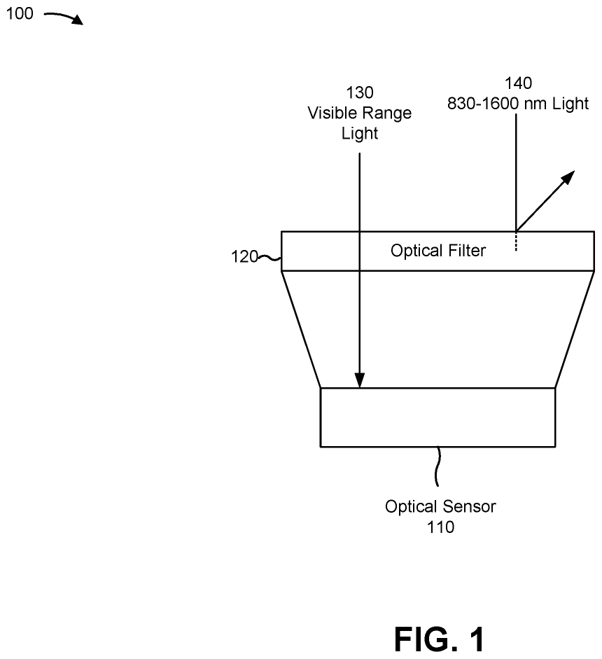

FIG. 1 is a diagram of an example device 100 described herein. Device 100 comprises any device that includes an optical sensor 110 and an optical filter 120. In some implementations, device 100 may be a sensor device, such as a spectrometer and/or the like. In some implementations, device 100 may include a camera system included in another device. For example, device 100 may be included in a user device (e.g., a user device including a smartphone camera system, a point-and-shoot camera system, a digital single reflex camera system, a camera system associated with a wearable device), a security device (e.g., a security camera associated with an automated teller machine, a bank security camera, a police body camera, a surveillance camera), a vehicle (e.g., a self-driving vehicle camera, a parking camera, a vehicle sensing system), an extended reality (XR) device (e.g., an augmented reality (AR) device, a virtual reality (VR) device, or a mixed reality (MR) device), and/or the like.

Optical sensor 110 includes a device capable of sensing light. For example, optical sensor 110 may include an image sensor, a multispectral sensor, a spectral sensor, and/or the like. In some implementations, optical sensor 110 may include a charge-coupled device (CCD) sensor, a complementary metal-oxide semiconductor (CMOS) sensor, and/or the like. In some implementations, optical sensor 110 may include a front-side illumination (FSI) sensor, a back-side illumination (BSI) sensor, and/or the like. In some implementations, optical sensor 110 may comprise a substrate (e.g., a silicon substrate and/or the like). For example, the substrate may be transmissive in at least part of a wavelength range of 830-1600 nm and may be absorptive or excitable in at least part of a visible wavelength range.

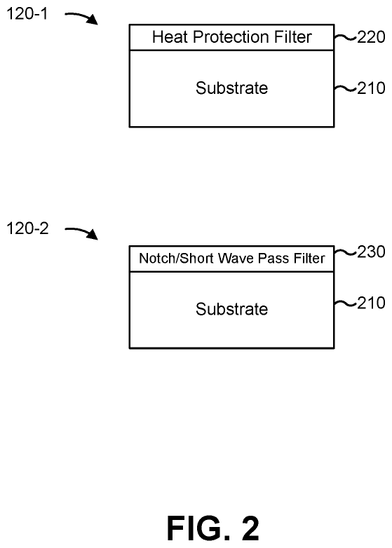

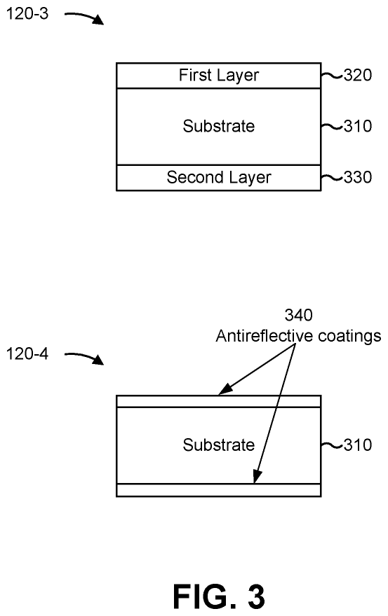

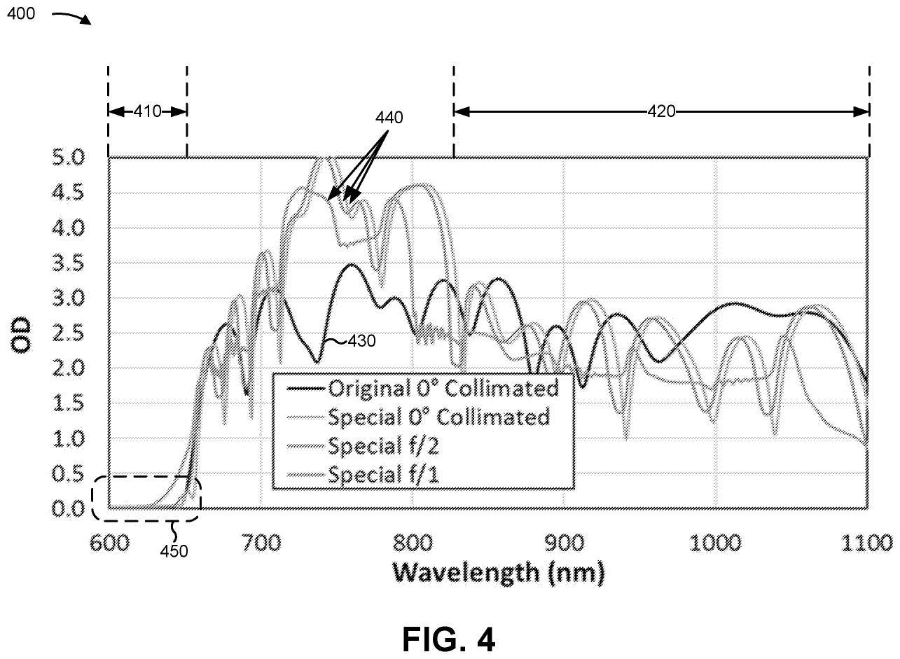

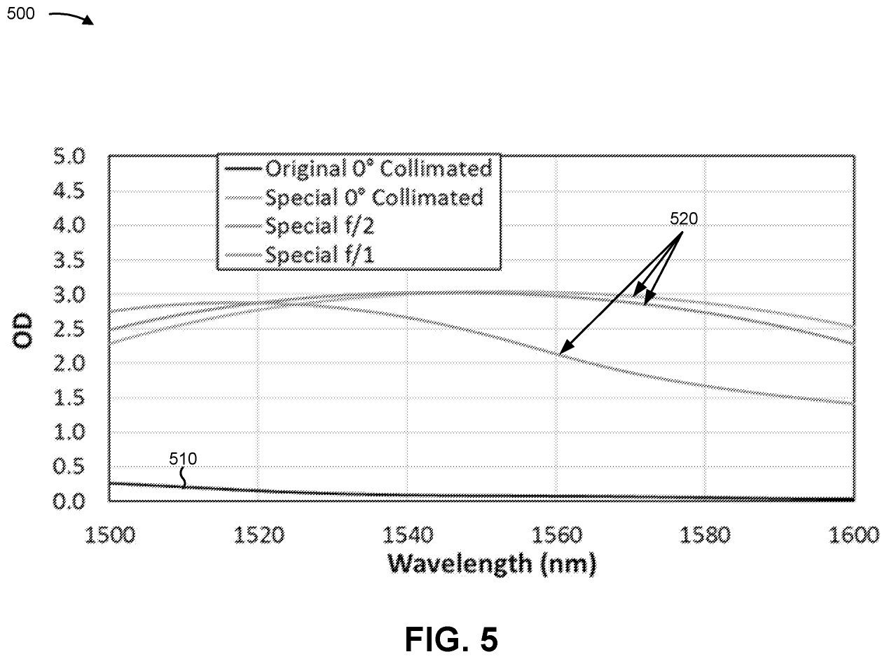

Optical filter 120 includes a filter that passes light in a visible range, as shown by reference number 130, and reflects and/or absorbs light in a wavelength range of 830-1600 nm, as shown by reference number 140. Examples of optical filter 120 are provided in FIGS. 2 and 3. In some implementations, optical filter 120 may pass a threshold amount of light in the visible range and reflect and/or absorb a threshold amount of light in the wavelength range of 830-1600 nm. For example, optical filter 120 may be associated with a first threshold optical density in the visible range and a second threshold optical density in the LIDAR or MR range. Examples of optical density curves of various configurations of optical filter 120 are provided in FIGS. 4 and 5.

In some aspects, optical filter 120 may be implemented at one or more points along an optical path of device 100. For example, optical filter 120 may be implemented at or near (e.g., within a threshold distance, such as within 1 cm) an entrance pupil of device 100. An entrance pupil refers to a vertex of a camera's angle of view. In some aspects, optical filter 120 may be implemented at or near (e.g., within a threshold distance, such as within 1 cm) an aperture stop of device 100. An aperture stop is a component that primarily determines a ray cone angle and brightness at an image point. In some aspects, optical filter 120 may be deposited on or implemented at or near optical sensor 110 (e.g., within a threshold distance, such as within 1 cm).

As indicated above, FIG. 1 is provided as an example. Other examples may differ from what is described with regard to FIG. 1.

FIGS. 2 and 3 are diagrams of examples of optical filters 120-1, 120-2, 120-3, and 120-4, such as those that may be used for an example device 100 described herein. As shown, in some implementations, optical filter 120-1 may include a substrate 210. Substrate 210 may be fabricated of any suitable material that is transparent in the visible range, such as a glass layer (e.g., a fused silica glass, a borofluid glass, and/or the like) and/or the like. In some implementations, substrate 210 may include or may be formed using a polymer (e.g., a polymer substrate, a polymer dye, a polymeric matrix, and/or the like) configured to pass light in the visible range and/or absorb light in a wavelength range of 830-1600 nm. In some aspects, substrate 210 may be a shortpass filter (e.g., a shortpass edge filter) with a transmittance (Tτᵢ) that satisfies a first threshold in the visible range and a transmittance that satisfies a second threshold in the infrared range, such as a transmittance greater than approximately 0.75 in a range of 365 nm to 600 nm and/or a transmittance less than approximately 0.1 in a range above 800 nm.

As further shown, optical filter 120-1 may include a heat protection filter 220 (e.g., a heat reflective glass, a heat absorbance glass, a combination thereof, and/or the like). Heat protection filter 220 may absorb and/or reflect light associated with a wavelength of 830-1600 nm, such as LIDAR light, MR light, and/or the like, and may pass light in the visible range. For example, heat protection filter 220 may block or absorb light associated with a wavelength of 830-1600 nm (e.g., at a transmittance that satisfies a threshold, such as less than approximately 0.1 in a range above 800 nm). In some implementations, optical filter 120-1 may not include a substrate 210. For example, optical filter 120-1 may include a heat protection filter 220 that is not deposited on a substrate 210, which may reduce the thickness of optical filter 120-1. In some aspects, substrate 210 may be a heat protection filter 220.

As shown, in some implementations, optical filter 120-2 may include a notch or short wave pass filter 230. The notch or short wave pass filter 230 may be configured to pass visible light and reflect or absorb light associated with a wavelength of 830-1600 nm. In some implementations, the notch or short wave pass filter may be coated or deposited on substrate 210.

As shown in FIG. 3 and with reference to optical filter 120-3, in some aspects, a substrate 310 (e.g., substrate 210 and/or the like) may be associated with at least one of a first layer 320 or a second layer 330. For example, the first layer and/or the second layer may be deposited on substrate 310. In some implementations, first layer 320 and/or second layer 330 may include heat protection filter 220, notch or short wave pass filter 230, one or more antireflective coatings 340 of optical filter 120-4, a thin film stack, a reflective or absorptive layer, or a combination thereof. In some implementations, optical filter 120 (e.g., optical filter 120-1, 120-2, 120-3, or 120-4) may include multiple first layers 320 on a first side of substrate 310 and/or multiple second layers 330 on a second side of substrate 310 opposite the first side. In some implementations, first layer 320 and/or second layer 330 may comprise an interference coating or an absorptive coating configured to absorb light at a threshold transmittance in at least part of a wavelength range of 830-1600 nm. For example, first layer 320 and/or second layer 330 may comprise a low angle shift coating material. In some implementations, first layer 320 and/or second layer 330 may comprise a reflective structure configured to reflect light in at least part of a wavelength range of 830-1600 nm. For example, first layer 320 and second layer 330 as reflective structures may be configured to cause interference in the range of 830-1600 nm and pass light in the visible range.

In some aspects, first layer 320 may include a coating of, for example, silicon dioxide (SiO2), niobium-tantalum (NbTa) oxide, niobium pentoxide (Nb2O5), tantalum pentoxide (Ta2O5), titanium dioxide (TiO2), niobium-titanium (NbTi) oxide, silicon nitride (Si3N4), hafnium dioxide (HfO2), aluminum oxide (Al2O3), indium tin oxide (ITO), praseodymium(III) oxide (Pr2O3), a combination thereof, or the like. This coating may supplement the absorption properties of the substrate 310 by providing reflection in certain ranges (e.g., ranges in which the substrate 310 is configured to absorb light) and transmission in other ranges (e.g., ranges in which the substrate 310 is configured to transmit light). In some aspects, first layer 320 may have a thickness in a range of 6 to 10 microns. In some aspects, first layer 320 may have a thickness of approximately 9 microns (e.g., 9.3 microns). In some aspects, first layer 320 may be deposited on a substrate 310, wherein substrate 310 has a thickness of approximately 3 mm. In some aspects, substrate 310 may have a thickness in a range of 2 mm to 5 mm. In some aspects, first layer 320 may be deposited on a substrate 310 that includes a shortpass filter, as described in more detail in connection with FIG. 2. In some aspects, second layer 330 may comprise an antireflective coating 340 (described in more detail below) and first layer 320 may include a coating of, for example, SiO2 and NbTa oxide. In some aspects, second layer 330 may comprise an antireflective coating and first layer 320 may include a coating of, for example, SiO2 and NbTa oxide, and substrate 310 may include a shortpass filter.

As shown, optical filter 120-4 may include one or more antireflective coatings 340. Antireflective coating 340 may reduce reflection of light from optical filter 120, which may be desirable to improve the rejection properties of optical filter 120. For example, an antireflective coating 340 on a back surface of optical filter 120 (e.g., a surface opposite where light enters optical filter 120, a surface opposite a world-facing side of optical filter 120) may reduce rejection loss of optical filter 120. As another example, an antireflective coating on a front surface of optical filter 120 (e.g., a surface where light enters optical filter 120) may improve performance of a notch filter of optical filter 120 and thus provide a more optimal infrared cut rejection curve. In some aspects, an antireflective coating may include an absorptive coating or a or an interference coating.

As indicated above, FIGS. 2 and 3 are provided as one or more examples. Other examples may differ from what is described with regard to FIGS. 2 and 3.

FIGS. 4-8 are example performance curves for optical filters 120 described herein.

FIG. 4 shows performance curves 400 in a visible range (e.g., sub-650 nm, shown by reference number 410) and a range of 830-1100 nm, shown by reference number 420. Generally, performance curves 400 illustrate an optical density (OD) of a filter with regard to various wavelengths of light. The OD of a filter at the various wavelengths of light may be referred to as performance of the filter. Performance of a reference optical filter (e.g., an optical filter that is not configured to reflect or absorb light in the wavelength range of 830-1600 nm) is shown by a black line indicated by reference number 430, and performance of optical filter 120 (e.g., at various angles of incidence of light, such as collimated, f/2, and f/1) is shown by the gray lines indicated by reference number 440. As shown by reference number 450, optical filter 120 passes light in the visible range (e.g., optical filter 120 may have a near-zero OD below approximately 650 nm). As shown, optical filter 120 blocks or reflects light (e.g., optical filter 120 may have a variable OD in a range of 3.0 to 1.0) in a wavelength range of 830-1100 nm shown by reference number 420. Furthermore, optical filter 120 is associated with a higher OD than the reference optical filter in a range of approximately 700-830 nm.

FIG. 5 shows performance curves 500 in a range of approximately 1500-1600 nm for a reference optical filter (shown using a black line as indicated by reference number 510) and an optical filter 120 (shown using gray lines as indicated by reference number 520) at various angles of incidence of light. As shown, optical filter 120 is associated with higher OD (e.g., approximately 3.0 to 1.5) than the reference optical filter (e.g., substantially zero) in the range of 1500-1600 nm. Thus, optical filter 120 may reduce the intensity of LIDAR or other laser light, thereby reducing damage and degradation for image sensors due to the LIDAR or other laser light.

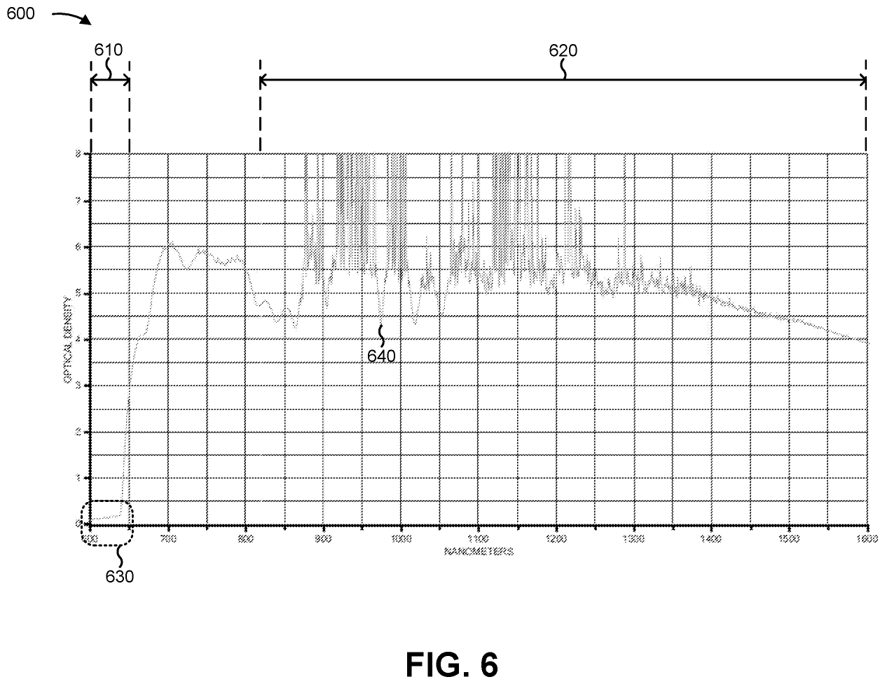

FIG. 6 is a diagram illustrating a performance curve 600 for optical filter 120. Performance curve 600 is expressed in units of OD relative to wavelengths of light, expressed in nanometers. FIG. 6 shows performance curve 600 in a visible range (e.g., sub-650 nm, shown by reference number 710) and a range of 830-1600 nm, shown by reference number 620. As shown by reference number 630, optical filter 120 passes light in the visible range (e.g., optical filter 120 may have a near-zero OD below approximately 650 nm). As shown by reference number 640, optical filter 120 blocks or reflects light (e.g., optical filter 120 may have a variable OD greater than 4.0) in a wavelength range of 830-1550 nm. Furthermore, optical filter 120 is associated with an OD of approximately 4.0 at a wavelength of 1600 nm.

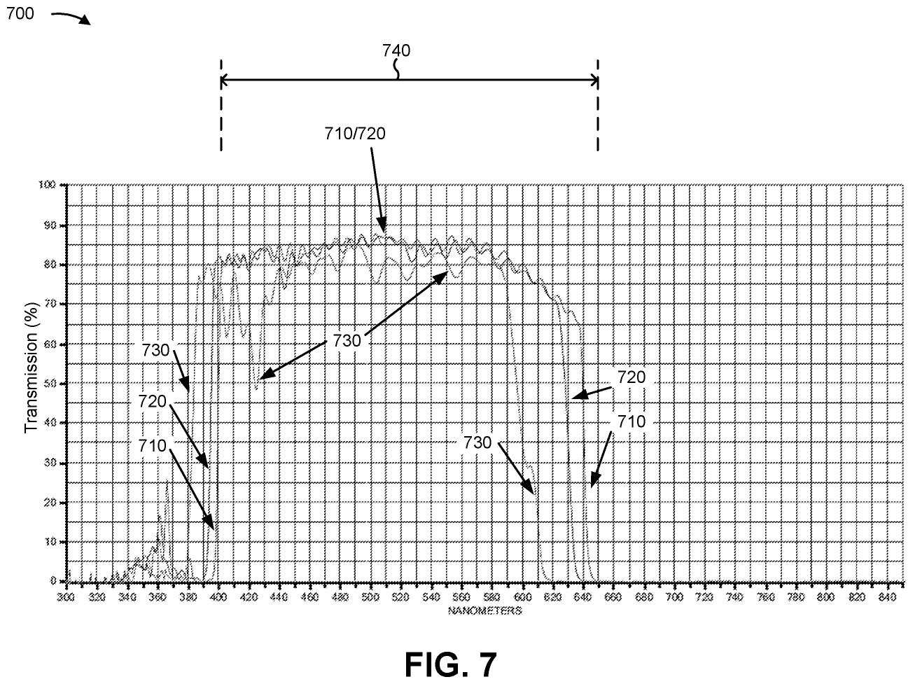

FIG. 7 is a diagram illustrating an example 700 of performance curves 710, 720, and 730 for optical filter 120. Performance curves 710, 720, and 730 show a percentage-based transmission of light at different wavelengths of light (expressed in nanometers). In example 700, performance curve 710 corresponds to a zero-degree angle of arrival, performance curve 720 corresponds to a 20 degree angle of arrival, and performance curve 730 corresponds to a 40 degree angle of arrival.

As shown in FIG. 7, optical filter 120 may be associated with a threshold transmission (e.g., above approximately 70%) in a visible range of light (e.g., in the range shown by reference number 740). As further shown, optical filter 120 may provide the threshold transmission even at relatively large angles of arrival (such as corresponding to performance curve 730). Generally, a larger angle of arrival (such as corresponding to performance curve 730) corresponds to more transmission at lower wavelengths, whereas a smaller angle of arrival (such as corresponding to performance curve 710) corresponds to more transmission at higher wavelengths. Furthermore, optical filter 120 provides substantially zero transmission at wavelengths above approximately 650 nanometers.

As indicated above, FIGS. 4-7 are provided as one or more examples. Other examples may differ from what is described with regard to FIGS. 4-7.

The foregoing disclosure provides illustration and description, but is not intended to be exhaustive or to limit the implementations to the precise forms disclosed. Modifications and variations may be made in light of the above disclosure or may be acquired from practice of the implementations.

Some implementations are described herein in connection with thresholds. As used herein, satisfying a threshold may, depending on the context, refer to a value being greater than the threshold, more than the threshold, higher than the threshold, greater than or equal to the threshold, less than the threshold, fewer than the threshold, lower than the threshold, less than or equal to the threshold, equal to the threshold, or the like.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, etc.), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A device, comprising:
an image sensor to capture an image using light in a visible range; and
an optical filter to filter light received by the image sensor,
wherein the optical filter passes light in the visible range, and
wherein the optical filter absorbs or reflects light in a wavelength range of 830 to 1600 nanometers (nm).

2. The device of claim 1, wherein the optical filter comprises:
a glass layer, and
at least one of:
a notch filter provided on or in the glass layer configured to absorb or reflect the light in the wavelength range of 830 nm to 1600 nm, or
a short wave pass filter provided on the glass layer configured to absorb or reflect the light in the wavelength range of 830 nm to 1600 nm.

3. The device of claim 1, wherein the optical filter further comprises a heat protection filter that absorbs or reflects the light in the wavelength range of 830 nm to 1600 nm.

4. The device of claim 1, wherein the optical filter further comprises a polymer substrate or a polymer dye that absorbs or reflects the light in the wavelength range of 830 nm to 1600 nm.

5. The device of claim 1, wherein the optical filter further comprises a first reflective or absorptive layer as a first surface of the filter and a second reflective or absorptive layer as a second surface of the filter.

6. The device of claim 1, wherein the optical filter further comprises one or more antireflective coatings on at least one of:
a first surface of the filter, or
a second surface of the filter opposite the first surface.

7. The device of claim 1, wherein the image sensor is degraded or damaged if the image sensor receives light of a threshold intensity in the wavelength range of 830 nm to 1600 nm.

8. The device of claim 1, wherein the device is included in a vehicle sensing system.

9. The device of claim 1, wherein the device is included in a camera system.

10. The device of claim 9, wherein the camera system comprises a smartphone camera system.

11. The device of claim 1, wherein the optical filter comprises a substrate that is a shortpass filter.

12. The device of claim 1, wherein the optical filter comprises an antireflective coating on a first side and a heat protection filter on a second side opposite the first side.

13. An optical filter, comprising:
a layer that passes light in a visible range, and
one or more filter elements,
wherein the optical filter is absorptive or reflective of light in a wavelength range of 830 to 1600 nanometers (nm).

14. The optical filter of claim 13, wherein the one or more filter elements comprise a notch filter or a short wave pass filter.

15. The optical filter of claim 13, wherein the one or more filter elements comprise a heat absorbance glass or a heat protection filter.

16. The optical filter of claim 13, wherein the one or more filter elements comprise a polymeric matrix on or in the layer.

17. The optical filter of claim 13, wherein the one or more filter elements comprise a thin film stack on the layer.

18. The optical filter of claim 13, further comprising a first reflective or absorptive layer as a first surface of the optical filter and a second reflective or absorptive layer as a second surface of the optical filter.

19. The optical filter of claim 13, further comprising antireflective coatings on a first surface of the optical filter and on a second surface of the optical filter opposite the first surface.

20. A camera, comprising:
an image sensor to capture an image using light in a visible range; and
a heat protection filter,
wherein the heat protection filter passes light in the visible range, and
wherein the heat protection filter absorbs or reflects light in a wavelength range of approximately 830 to 1600 nanometers (nm).
